(19) United States
(12) Patent Application Publication
(10) Pub. No.: US 2010/0077892 A1
(43) Pub. Date: Apr. 1, 2010

(54) FORCING TOOL

(75) Inventor: Jeffrey Charles Bishop, Derby (GB)

Correspondence Address: OLIFF & BERRIDGE, PLC, P.O. BOX 320850, ALEXANDRIA, VA, 22320-4850, US

(73) Assignee: Rolls-Royce plc, London (GB)

(21) Appl. No.: 12/312,283

(22) PCT Filed: Nov. 19, 2007
(86) PCT No.: PCT/GB2007/004409

§ 371 Date: Jun. 4, 2009

(30) Foreign Application Priority Data
Dec. 16, 2006 (GB) 0625111.0

(51) Int. Cl. B25B 13/50; B25B 13/06

(52) U.S. Cl. 81/124.3

(57) ABSTRACT

A forcing tool is provided in which a lobe aperture incorporates opposed lobe pairs having driving flanks. Distal ends of the driving flanks define a spacing consistent with the width of a dowel or tang to be utilized in a twisted-dowel joint. The aperture incorporates location recesses to allow the dowel or tang to pass through the aperture and then through twisting create a lock condition.

The present invention relates to forcing tools and more particularly to a forcing tool utilised with regard to so called “twisted-dowel” or “tang” joints in order to force the dowel or tang out of alignment with a slot to form a joint for retention of sheets of material together.

Creating joints and fastenings is an inherent requirement in a large number of constructions, fabrications and assemblies. It will be appreciated that there are a number of joints and fastening regimes available including rivets, nuts and bolts, adhesives and interference fasteners. More recently, and as outlined in European patent No. 1259339, so called “twisted-dowel” or “tang” joints have been described in which a section of material extends or projects through a slot and part of the projection is twisted out of alignment with the slot or aperture in order to create an interference for location of a joint particularly between sheets of material.

These twisted-dowel or tang joints have particular advantages in that they are relatively strong and quick to form as well as, dependent upon the material from which the dowel or tang is made, allow release as necessary by reverse twisting. Issues with different materials and different mechanical properties are also avoided as well as the cost and space requirements of separate fasteners. Unfortunately, as a dowel or tang projecting through a slot aperture it will be understood it is easy to use inappropriate forcing tools such as pliers, grips, adjustable wrenches or open ended spanners in order to force rotation of the dowel or tang. Such an approach can lead to inappropriate twisting of the dowel or tang such that a helical slip ramp is created with abrupt release of the forcing tool, that is to say pliers, grips, wrenches or spanners. Such abrupt release of the forcing tool can cause damage to the user and/or damage to the effectiveness and sustainability of the joint. It will also be understood that release of the twisted dowel joint may also be more difficult.

In accordance with aspects of the present invention there is provided a forcing tool for a dowel or tang joint, the tool arranged to engage a dowel or tang in use to twist the dowel or tang out of alignment with a slot aperture to form a joint, the forcing tool characterised in that the tool incorporates a lobe aperture comprising opposed lobes, each lobe having a recess, the recesses in opposed lobes having a spacing therebetween being substantially equivalent to the maximum width of the dowel or tang, each lobe further having a driving flank and each driving flank having a distal end spaced from the other distal end in the opposed lobes by a spacing substantially equivalent to an under-shoulder width of the dowel or a tang such that the tool is locked in a desired configuration relative to the dowel or tang.

Generally, the lobe aperture comprises four lobes arranged in a cross. Typically, the lobe aperture is at one end of the tool.

Generally, opposed lobes are at an angle to the major axis of the tool. Typically, the angle is in the range 15-30°. Advantageously, the angle is in the range 20-25°. Most advantageously, the angle is substantially 22.5°.

Possibly, the lobe aperture is configured to locate below detents of a dowel or tang in use. Generally, the tool has a thickness about the lobe aperture substantially the same as a dowel or tang.

Generally, each lobe of the opposed lobes has a location recess. Generally, the location recesses allow entry of the dowel or tang into the lobe aperture over the detents as described above.

Possibly, the tool incorporates two or more opposed lobes as lobe pairs for respective sizes of dowel or a tang in terms of the width of each size of dowel or tang.

Generally, the tool is made from substantially the same material as the dowel or tang.

Possibly, the tool has a neck crank to present a handle portion upwards in use as the lobe aperture is substantially perpendicular to the dowel or tang. Generally, parts of the tool about the lobe aperture are shaped and configured to lie upon an area about a slot aperture in use.

Generally, the detents are provided to retain tool engagement about the dowel or tang upon rotation of the dowel or tang to form a joint in accordance with aspects of the present invention.

An embodiment of a forcing tool in accordance with aspects of the present invention will now be described by way of example only and with reference to the accompanying drawings in which:

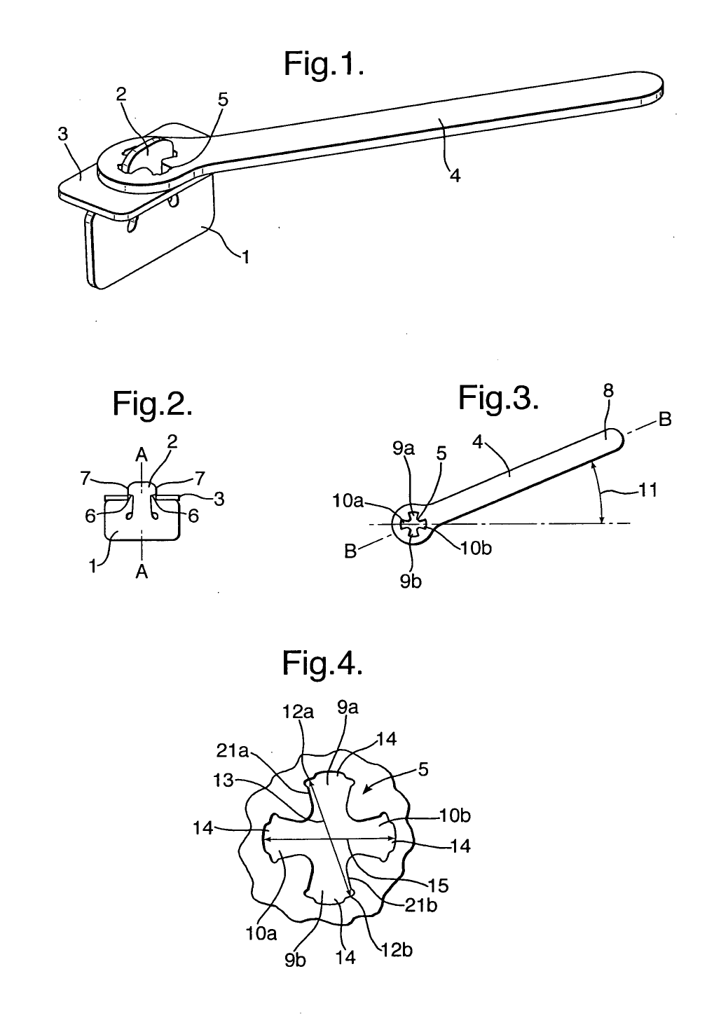

FIG. 1 is a schematic view of a twisted-dowel or tang joint with a forcing tool in accordance with aspects of the present invention;

FIG. 2 is a schematic cross section of a twisted-dowel joint in accordance with aspects of the present invention;

FIG. 3 is a schematic plan view of a forcing tool in accordance with aspects of the present invention; and,

FIG. 4 is a schematic plan view of a lobe aperture in accordance with aspects of the present invention.

As indicated above, twisted-dowel or tang joints are useful particularly with regard to securing sheets of material together. An example of such a joint is provided in European patent No. 1259339. It will be understood essentially a dowel or tang extends through overlaying apertures in sheets of material and is then twisted out of alignment with an aperture slot to secure those sheets of material together. FIG. 1 illustrates a typical twisted-dowel or tang joint configuration with associated forcing tool in accordance with aspects of the present invention as a schematic front perspective. Thus, a dowel or tang member 1 presents a dowel or tang 2 which extends through an aperture (not shown) in a sheet 3. It will be understood possibly several sheets of material may be held together by the tang 2 or the tang member 1 itself may be welded or otherwise secured to another component with location provided by the tang 2. Such refinements are not incorporated in FIG. 1 for clarity.

As will be seen, the tang 2 extending through the material sheet 3 is engaged by a forcing tool 4. It will be understood that the tool 4 incorporates at one end a lobe aperture 5 in accordance with aspects of the present invention in order to ensure appropriate twisting or forcing of the tang 2 out of alignment with slot in the sheet 3. The lobe aperture 5 in accordance with aspects of the present invention is particularly configured to ensure consistent twisting of the tang or dowel 2 in order to create an effective joint. By such an approach the tool 4 avoids potential problems with prior use of generally inappropriate pliers, wrenches and spanners for effecting turning of the dowel or tang 2 into a joint configuration. The lobe aperture 5 ensures robust and correct association between the tool 4 and the tang or dowel 2.

FIG. 2 shows a side cross section of the twisted-dowel or tang joint configuration depicted in FIG. 1 with the forcing tool 4 removed. Thus, the dowel or tang 2 extends through an aperture in the material sheet with mating shoulders 6 positioned such that when the dowel or tang 2 is turned about an axis A-A it will be understood that these mating shoulders 6 engage parts either side of the slot in the material sheet 3 to cause a joint.

In accordance with aspects of the present invention typically detents 7 are provided in the dowel or tang 2 spaced away from an upper surface of the material sheet 3. These detents 7 provide register for the dowel or tang 2 in the slot formed in the material sheet 3 as required. These detents 7, as will be described later, are utilised to further urge and facilitate desired orientation of the forcing tool 4 relative to the tang or dowel 2. In short, the thickness of the tool 4 about the lobe aperture 5 is generally the same as the offset of the detents from the upper surface of the material sheet 3 in order to create a locking and register between the tool 4 and the tang or dowel 2. Such an approach may allow the present forcing tool to be cut or otherwise formed from the same sheet of material as the tangs/dowels.

It will also be understood that generally the area about the lobe aperture of the tool is such that it is consistent with the shaping and configuration of the surface of the material sheet 3 about the aperture through which the tang or dowel 2 extends. Normally, such relationship and configuration is a flat surface to surface abutment. In such circumstances urging of correct orientation between the tool 4 and the dowel or tang 2 is facilitated by capture between the detent 7 and the upper surface of the material sheet 3 and surface to surface contact as well as the registered depth as will be described later between the lobe apertures and end parts of the dowel or tang 2. The dowel or tang 2 is confined within the lobe aperture 5 and therefore correct orientation is achieved and retained due to the construction of the dowel or tang 2 within the lobe aperture 5.

FIG. 3 provides a schematic plan view of the forcing tool 4 depicted in FIG. 1. Thus, the tool 4 is generally elongate with a major axis B-B such that the lobe aperture 5 is formed at one end whilst another end 8 of the tool 4 defines the extent of a handle portion for mechanical leverage in order to twist a dowel or tang 2 (FIGS. 1 and 2) in order to define a joint in accordance with a twisted-dowel or tang configuration.

Although it is possible to define a tool incorporating a single pair of opposed lobes, as can be seen in FIG. 3, generally a cross configuration is advantageous. Thus, respective opposed lobe pairs 9a, 9b; 10a, 10b are provided. For convenience of operation generally the cross of the lobe aperture 5 is arranged to be at an angle 11 to the major axis B-B of the tool 4. The angle 11 can be any suitable for convenience but will typically be in the range 15-30° or more likely in the range 20-25°, but most preferably about 22.5° to the major axis B-B of the tool 4. Such an angle generally allows alternatives by turn over when attempting to present the tool to a tang in a confined or awkward position.

As depicted in FIG. 3 the opposed lobe pairs 9a, 9b; 10a, 10b are generally of the same size to provide convenience of use. In such circumstances the tool 4 will be spaced for a particular size of dowel or tang and so that tool 4 selected when that particular dowel or tang size is present. Alternatively, in the cross configuration of a lobe aperture it will be appreciated that there may be different sizing in the respective opposed lobes as will be described later in order to accommodate different sized dowels or tangs in accordance with aspects of the present invention. Furthermore, the tool may be adapted to provide a lobe aperture at both ends with different or similar sized opposed lobe pairs in those ends as required for convenience and operational purposes. In such circumstances although not shown in FIG. 3, a lobe aperture may also be provided at end 8.

In accordance with aspects of the present invention matching of the lobe aperture 5 with particularly a width dimension of the dowel or tang 2 ensures appropriate configuration or urging towards that configuration for the tool in use. In such circumstances, as depicted in FIG. 4 showing in greater plan view the lobe aperture 5, it will be seen that the aperture 5 is a generally cross configuration as described previously with respective driving flanks 21 arranged to engage the dowel or tang (not shown) in use. In such circumstances between the far distal ends 12 of the driving flanks 21, there is a distance or spacing 13 substantially consistent with the width of the dowel or tang (not shown) for which the lobe aperture 5 is configured. In such circumstances it will be understood that the aperture 5 has a depth of substantially perpendicular material which registers with a similar depth of the tang between the detents 7 and the upper surface of the material sheet 3 such that there is a generally snug association urging correct orientation, that is to say substantially perpendicular to the surface about the aperture through which the dowel or tang extends.

Clearly, the detents 7 extend laterally and typically overhang the general width of the dowel or tang 2 consistent with the spacing 13 between the distal ends 12 of the flanks 21. In such circumstances in order to allow over presentation of the aperture 5, it will be understood that location recesses 14 are provided. These recesses 14 extend outwardly and radially from a centre (A-A) of the aperture 5 to allow the aperture 5 to pass over the detents 7 in the dowel or tang (not shown). Once located it will be understood that the under cut of the dowel or tang 2 below the detents 7 will then be generally consistent with the width or spacing 13 between the distal ends 12 such that rotation of the tool will cause the driving flanks 21 to engage and so turn the dowel or tang 2 in use to form a joint. FIG. 1 illustrates this central positioning prior to turning of the tool 4 where the tool 4 is arranged such that the detents 7 align with the location recesses 14. In such circumstances a diagonal 15 between location recesses 14 will be consistent with the maximum width of the dowel or tang 2 (not shown).

In use, as indicated, initially the tool will be positioned by locating and passing the lobed aperture 5 over the dowel or tang 2 and in alignment with the detents. Once in this position the tool will be turned beneath the detents 7 such that the tool is locked in a desired configuration and urged to that configuration by the spacing 13 of the aperture 5. In such circumstances, the likelihood of forcing tool 4 slip off or damage to the dowel or tang 2 is removed or at least reduced. Furthermore, due to the robust turning of the dowel or tang, a more appropriate joint will be created. Substantially through the turning process for the tool and the dowel or tang 2 as indicated the tool 4 is locked to the dowel or tang 2 such that the driving flanks 21 can create an even and consistent load to the tang or dowel 2. Close conformity will prevent buckling in the tang or dowel with a reduced risk of cracking and failure of the dowel 2 during turning. Once the tang or dowel 2 is appropriately positioned it will be understood that the tool can be removed by a simple undoing action, that is to say reversing the direction of rotation until there is dis-engagement and then lifting the tool such that the dowel or tang passes through the aperture 5 about the location recesses 14 and the tool 4 can be lifted off.

As depicted in FIG. 1 in particular, generally the tool 4 may be flat and therefore consistent with a sheet 3. Alternatively, for convenience, a neck crank can be located in a position between the end incorporating the lobe aperture 5 and the other end 8 such that a part of the tool towards the other end 8 is uplifted to facilitate turning. This uplifted end acts as a handle portion.

The tool 4 will be formed from a similar or the same material as the dowels or tangs 2. The tool 4 may also be formed by an appropriate cutting technique such as by utilisation of a laser cutter which may also be used to form the dowel members or elements 1 incorporating the dowel or tangs 2.

It will be understood that it is the association between the lobe aperture 5 and the dowel or tang 2 which is important in accordance with aspects of the present invention. In such circumstances in addition to providing a passive tool 4 comprising a simple bar for leverage to turn the tang 2 it will also be understood that a torque wrench facility may be provided at an intermediate section between the end incorporating the lobe aperture and the other end 8 of the tool 4. In such circumstances the torque level can be set such that over turning and stressing of the dowel or tang can be avoided. It will also be understood that typically with small and lightweight components, the effective lock between the lobe aperture and the dowel or tang 2 in the turned configuration is sufficient that there is positive association in order to enable lifting and suspending of the components upon the tool 4 in use.

Due to the urging and correct orientation of the tool and in particular the lobe aperture 5 relative to the dowel or tang 2 it will be understood that slippage is avoided and therefore it is generally easy to tighten the dowel or tang to form a joint and furthermore such tightening will be correct resulting in a probable improvement in joint strength. Additionally, due to the limited slippage it will be understood that damage, such as so called “spanner rash” or bruising may be reduced and scratches and scraping on the dowel 2 is eliminated. Repeatability with regard to application and presentation of the tool 4 to dowels 2 in accordance with aspects of the present invention result in a consistency with regard to forming joints which increases predictability. As indicated above, it is possible to provide twisted dowel joints which are generally re-usable subject to the ability of the material from which the dowels 2 are formed being able to withstand such repeated twisting whilst also ensuring a robust joint is created. Consistency with regard to twisting as achieved through a forcing tool in accordance with aspects of the present invention will ensure that the possibility of such re-usability with respect to twisted-dowel joints is increased.

As indicated above, generally at least about the lobe aperture 5 there will be substantive consistency between the thickness of the tool in accordance with aspects of the present invention and the overhang depth between the detents and the surface of an aperture through which the dowel extends. Typical thicknesses are in the order of 1 mm however, the thickness of the material will also depend upon the strength of twisted-dowel joint required. The leverage advantage of the tool to a handle portion end will also be chosen in order to allow turning of the dowel in use. Possibly, dowels and therefore the tool may be formed from a metal such as steel.

Although a forcing tool has been described that may be used by hand to form a dowel or tang joint, it will be understood that the lobes and recesses of the present invention may be located for use with a machine tool to automate use of the forcing tool. This enables the forcing tool to be used in mass production situations in which it is important to have a tool that does not cause spanner rash and the like.

Modifications and alterations to aspects of the present invention will be appreciated by those skilled in the art. Thus, in addition to provision of cross lobe apertures it will also be understood that, where feasible and practical, three opposed lobe apertures can be provided of similar or different sizes dependent upon requirements. Furthermore, where desirable to improve engagement loading, the driving flanks may be treated in order to be more robust and toughened to reduce deformation in use which may alter the dimensions within the lobe aperture and so create over sizing which will result in less consistent urging of the tool into engagement with the dowel or tang.

1. A forcing tool for a dowel or tang joint, the tool arranged to engage a dowel or tang in use to twist the dowel or tang out of alignment with a slot aperture to form a joint, wherein the forcing tool incorporates a lobe aperture comprising opposed lobes, each lobe having a recess, the recesses in opposed lobes having a spacing therebetween being substantially equivalent to the maximum width of the dowel or tang, each lobe further having a driving flank and each driving flank having a distal end spaced from the other distal end in the opposed lobes by a spacing substantially equivalent to an under-shoulder width of the dowel or a tang such that the tool is locked in a desired configuration relative to the dowel or tang.

2. A tool as claimed in claim 1, wherein the lobe aperture comprises four lobes arranged in a cross.

3. A tool as claimed in claim 1, wherein the lobe aperture is at one end of the tool.

4. A tool as claimed in claim 1, wherein opposed lobes are at an angle to the major axis of the tool.

5. A tool as claimed in claim 4, wherein the angle is in the range 15-30°.

6. A tool as claimed in claim 1, wherein the lobe aperture is configured to locate below detents of a dowel or tang in use.

7. A tool as claimed in claim 1, wherein the tool has a thickness about the lobe aperture substantially the same as a dowel or tang to be engaged by the tool.

8. A tool as claimed in claim 1, wherein each lobe of the opposed lobes has a location recess.

9. A tool as claimed in claim 6, wherein each lobe of the opposed lobes has a location recess and the location recesses allow entry of the dowel or tang into the lobe aperture over the detents.

10. A tool as claimed in claim 1, wherein the tool incorporates two or more opposed lobes as lobe pairs for respective sizes of dowel or tang in terms of the width of each size of dowel or tang.

11. A tool as claimed in claim 1, wherein the tool is made from substantially the same material as the dowel or tang.

12. A tool as claimed in claim 1, wherein the tool has a neck crank to present a handle portion upwards in use as the lobe aperture is substantially perpendicular to the dowel or tang.

13. A tool as claimed in claim 1, wherein parts of the tool about the lobe aperture are shaped and configured to lie upon an area about a slot aperture in use.

14. A tool as claimed in claim 6, wherein the detents are provided to retain tool engagement about the dowel or tang upon rotation of the dowel or tang to form a joint.
